(19) United States
(12) Patent Application Publication
(10) Pub. No.: US 2019/0251587 A1
(43) Pub. Date: Aug. 15, 2019

(54) INFORMATION PROVIDING DEVICE, INFORMATION PROVIDING PROGRAM AND INFORMATION PROVIDING METHOD

(71) Applicant: Toyota Jidosha Kabushiki Kaisha, Toyota-shi Aichi-ken (JP)

(72) Inventors: Kazuhiro Umeda, Nisshin-shi Aichi-ken (JP); Takumi Fukunaga, Nisshin-shi Aichi-ken (JP); Makoto Akahane, Nagoya-shi Aichi-ken (JP); Satoshi Usui, Machida-shi Tokyo (JP)

(73) Assignee: Toyota Jidosha Kabushiki Kaisha, Toyota-shi Aichi-ken (JP)

(21) Appl. No.: 16/272,205

(22) Filed: Feb. 11, 2019

(30) Foreign Application Priority Data
Feb. 13, 2018 (JP) 2018-023160

(51) Int. Cl. G06Q 30/02; G06Q 30/06; G06Q 10/10; G01C 21/34

(52) U.S. Cl. CPC G06Q 30/0206; G01C 21/3438; G06Q 10/1093; G06Q 30/0645

(57) ABSTRACT

An information providing device includes: an acquisition unit configured to acquire return information indicating a first spot and a first date and time; a determination unit configured to determine at least one of a first charge and a first privilege based on the return information; and a sending unit configured to send information indicating at least one of the first charge and the first privilege.

### CROSS-REFERENCE TO RELATED APPLICATION

This application claims priority to Japanese Patent Application No. 2018-023160 filed on Feb. 13, 2018, incorporated herein by reference in its entirety.

### BACKGROUND

### 1. Technical Field

The disclosure relates to an information providing device, an information providing program and an information providing method.

### 2. Description of Related Art

Japanese Patent Application Publication No. 2012-215921 discloses a car station load distribution system including: a CS installation information DB that includes position information about installation places of a plurality of car stations (CSs) and information about a nearest facility; a CS use condition DB that thoroughly records entering hours and leaving hours of shared cars to enter and leave the CSs and that stores use conditions of the CSs; a shared car reservation acceptance unit that accepts a reservation for a shared car from a member of a car sharing; a CS congestion degree determination unit that determines congestion degrees of the CSs based on the CS use condition DB; and an alternative CS presentation unit that presents, on a terminal of the member, an alternative CS that is an alternative for a CS as a destination of the member, based on the CS installation information DB, in the case where the congestion degree of the CS as the destination of the member is higher than a predetermined value when the shared car reservation acceptance unit accepts the reservation for the shared car.

### SUMMARY

In the car station load distribution system, it is possible to thoroughly know demands for the CSs and to distribute use load, but it is not always possible to lead a vehicle for the car sharing to a place where the demand is high. Further, in the case where the CSs are not heavily congested, it is desirable to lead the vehicle for the car sharing to the place where the demand is high.

Hence, the disclosure provides an information providing device, an information providing program and an information providing method that can lead the vehicle for the car sharing to the place where the demand is high.

An information providing device according to a first aspect of the disclosure includes: an acquisition unit configured to acquire return information indicating a first spot and a first date and time, the first spot being a spot where a first user hopes to return a vehicle, the first date and time being a date and time when the first user hopes to return the vehicle; a determination unit configured to determine at least one of a first charge and a first privilege based on the return information, the first charge being a charge about use of the vehicle when the vehicle is returned at the first spot on the first date and time, the first privilege being a privilege about the use of the vehicle when the vehicle is returned at the first spot on the first date and time; and a sending unit configured to send information indicating at least one of the first charge and the first privilege.

In the first aspect, the determination unit may be configured to perform at least one of a process of decreasing the first charge as a demand is higher and a process of increasing the first privilege as the demand is higher, the demand being a demand for the vehicle at the first spot in a predetermined time after the first date and time.

In the first aspect, the determination unit may be configured to perform at least one of a process of decreasing the first charge as the number of users is larger and a process of increasing the first privilege as the number of the users is larger, each of the users being a user that hopes to use the vehicle that is to be returned at the first spot in the predetermined time after the first date and time.

In the first aspect, the determination unit may be configured to perform at least one of a process of decreasing the first charge as a grade of a second user is higher and a process of increasing the first privilege as the grade of the second user is higher, the second user being a user that hopes to use the vehicle that is to be returned at the first spot in the predetermined time after the first date and time.

In the first aspect, the determination unit may be configured to perform at least one of a process of decreasing the first charge as a demand is higher and a process of increasing the first privilege as the demand is higher, the demand being a demand for a car sharing service at the first spot in a predetermined time after the first date and time.

In the first aspect, the determination unit may be configured to perform at least one of a process of decreasing the first charge as the number of users is larger and a process of increasing the first privilege as the number of the users is larger, each of the users being a user that hopes to use the car sharing service at the first spot in the predetermined time after first the date and time.

In the first aspect, the determination unit may be configured to perform at least one of a process of decreasing the first charge as a grade of a second user is higher and a process of increasing the first privilege as the grade of the second user is higher, the second user being a user that hopes to use the car sharing service at the first spot in the predetermined time after the first date and time.

In the first aspect, the acquisition unit may be configured to further acquire preliminary information indicating a second spot and a second date and time, the second spot being different from the first spot, the second date and time being a date and time when the vehicle is returned at the second spot. The determination unit may be configured to further determine at least one of a second charge and a second privilege based on the preliminary information, the second charge being a charge about the use of the vehicle when the vehicle is returned at the second spot on the second date and time and being lower than the first charge, the second privilege being a privilege about the use of the vehicle when the vehicle is returned at the second spot on the second date and time and being higher than the first privilege. The sending unit may be configured to further send information indicating at least one of the second charge and the second privilege.

According to a second aspect of the disclosure, a non-transitory computer readable storage medium has computer program instructions stored thereon. When executed by a computer, the computer program instructions can cause the computer to execute: an acquisition function to acquire return information indicating a first spot and a first date and time, the first spot being a spot where a user hopes to return a vehicle, the first date and time being a date and time when the user hopes to return the vehicle; a determination function to determine at least one of a first charge and a first privilege based on the return information, the first charge being a charge about use of the vehicle when the vehicle is returned at the first spot on the first date and time, the first privilege being a privilege about the use of the vehicle when the vehicle is returned at the first spot on the first date and time; and a sending function to send information indicating at least one of the first charge and the first privilege.

An information providing method according to a third aspect of the disclosure includes: acquiring return information indicating a first spot and a first date and time, the first spot being a spot where a user hopes to return a vehicle, the first date and time being a date and time when the user hopes to return the vehicle; determining at least one of a first charge and a first privilege based on the return information, the first charge being a charge about use of the vehicle when the vehicle is returned at the first spot on the first date and time, the first privilege being a privilege about the use of the vehicle when the vehicle is returned at the first spot on the first date and time; and sending information indicating at least one of the first charge and the first privilege.

With the disclosure, it is possible to provide an information providing device, an information providing program and an information providing method that can lead the vehicle for the car sharing to the place where the demand is high.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing an exemplary configuration of an information providing device and a terminal according to an embodiment;

FIG. 2 is a diagram showing an exemplary relation of a first spot, a first date and time, the number and grades of users for the first spot and the first date and time, a first charge, and a first privilege according to the embodiment;

FIG. 3 is a diagram showing an exemplary relation of a second spot, a second date and time, the number and grades of users for the second spot and the second date and time, a second charge, and a second privilege according to the embodiment; and

FIG. 4 is a sequence diagram showing an exemplary process to be performed by the information providing device and the terminal according to the embodiment.

### DETAILED DESCRIPTION

Embodiments of the disclosure will be described with reference to the accompanying drawings. In the drawings, elements denoted by identical reference characters have identical or similar configurations.

### Embodiment

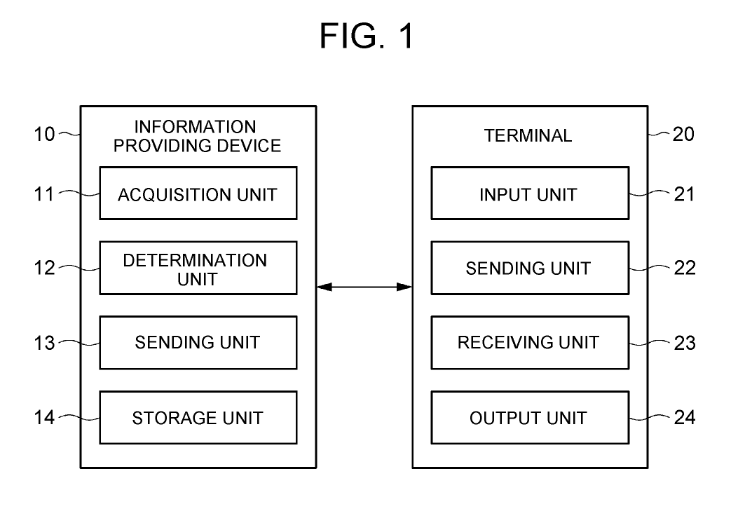

A configuration of an information providing device and a terminal according to an embodiment will be described with reference to FIG. 1.

For example, an information providing device 10 is a server that is used for providing a car sharing service, and includes an acquisition unit 11, a determination unit 12, a sending unit 13 and a storage unit 14, as shown in FIG. 1. In some embodiments, the information providing device 10 includes at least the acquisition unit 11, the determination unit 12 and the sending unit 13. In some embodiments, the information providing device 10 may use other devices having functions that are equivalent to the acquisition unit 11, the determination unit 12, the sending unit 13 and the storage unit 14.

For example, the terminal 20 is an information processing device such as a smartphone or PC possessed by a user that uses a car sharing service, and a car navigation device mounted on a vehicle to be used by the user, and includes an input unit 21, a sending unit 22, a receiving unit 23 and an output unit 24, as shown in FIG. 1. In some embodiments, the terminal 20 includes at least the input unit 21 and the output unit 24. In some embodiments, the terminal 20 may use other devices having functions that are equivalent to the input unit 21, the sending unit 22, the receiving unit 23 and the output unit 24.

The information providing device 10 and the terminal 20 may include other constituent elements other than the constituent elements shown in FIG. 1.

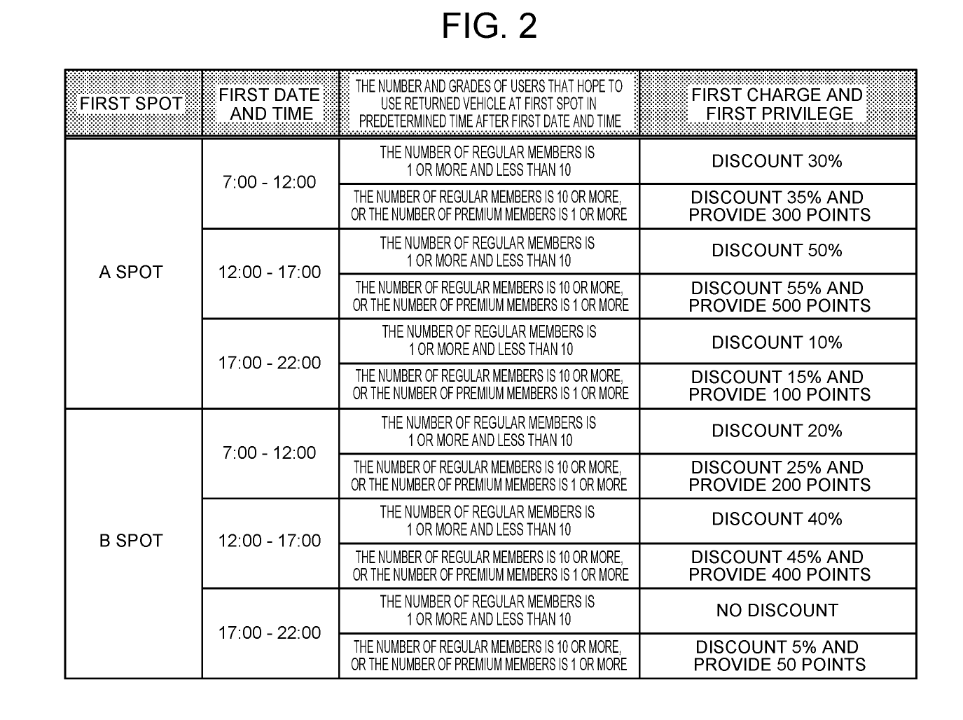

The acquisition unit 11 acquires return information indicating a first spot and a first date and time. The first spot is a spot where the user (first user) hopes to return a vehicle. The first date and time is a date and time when the user hopes to return the vehicle. The vehicle herein is a vehicle that is rented to the user in the car sharing service. The first date and time is an arbitrary period of time such as an arbitrary hour or the whole day on an arbitrary date. As the return information, the acquisition unit 1 acquires the first spot and first date and time input to the terminal 20 by the user. For example, the acquisition unit 11 acquires the return information indicating “A SPOT” shown in FIG. 2 and “7: 00˜12: 00” shown in FIG. 2. The return information is sent from the terminal 20 to the information providing device 10.

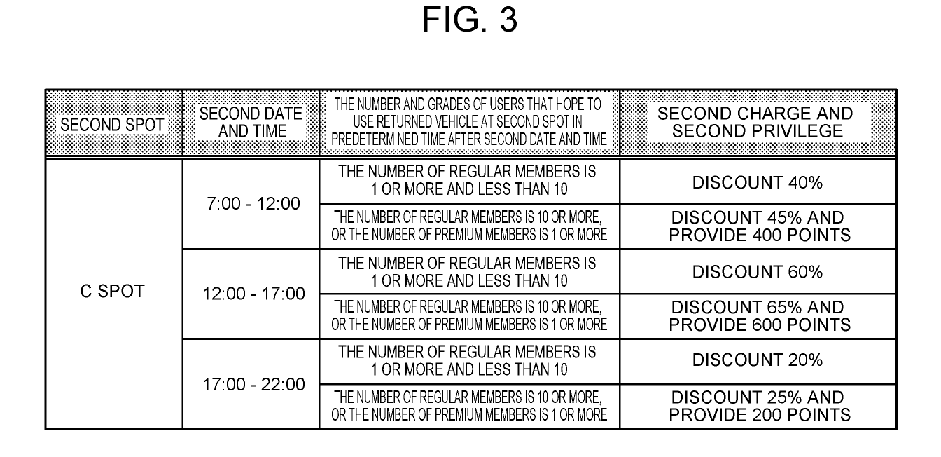

Further, the acquisition unit 11 can acquire preliminary information indicating a second spot and a second date and time. The second spot is different from the first spot. The second date and time is a date and time when the vehicle is returned at the second spot. Here, the second spot is a spot different from the spot where the user hopes to return the vehicle, and in some embodiments, should be close to the first spot. The second date and time is an arbitrary period of time such as an arbitrary hour or the whole day on an arbitrary date. Some of the second date and time may overlap with the first date and time, or the second date and time may not overlap with the first date and time at all. As the preliminary information, the acquisition unit 11 acquires, from the storage unit 14, the second spot and second date and time respectively associated with the first spot and first date and time input to the terminal 20 by the user. For example, the acquisition unit 11 acquires the preliminary information indicating “C SPOT” shown in FIG. 3 and “7: 00˜12: 00” shown in FIG. 3. It is allowed for the acquisition unit 11 not to acquire the preliminary information.

As the second spot, the acquisition unit 11 may acquire a spot where the number of users that hope to use the returned vehicle or the number of users that hope to use the car sharing service is large, or a spot where grades of the users are high. In this case, for example, each user inputs a spot where the user hopes to use the returned vehicle or to use the car sharing service, to a user's own portable terminal, and thereby, the preliminary information is generated and is stored in the storage unit 14.

The determination unit 12 determines at least one of a first charge and a first privilege based on the return information. The first charge is a charge about the use of the vehicle when the vehicle is returned at the first spot on the first date and time. The first privilege is a privilege about the use of the vehicle when the vehicle is returned at the first spot on the first date and time.

For example, as shown in FIG. 2, in the case where the first date and time is “7: 00˜12: 00”, where the number of premium members that hope to use the returned vehicle is one and where the first spot is “A SPOT”, the determination unit 12 adopts a charge resulting from discounting 35% from an original charge, as the first charge, and adopts provision of 300 points, as the first privilege. Here, the premium member is a member that is favored over a regular member in the use of the car sharing service. The point is set to a value equivalent to one yen per point, for example.

Meanwhile, in the case where the first date and time and users that hope to use the returned vehicle are the same as those in the above example and where the first spot is “B SPOT” differently from that in the above example, the determination unit 12 adopts a charge resulting from discounting 25% from an original charge, as the first charge, and adopts provision of 200 points, as the first privilege. Similarly, in the case where the first spot is “B SPOT”, where the first date and time is “12: 00˜17: 00” or “17: 00˜22: 00” or where users that hope to use the returned vehicle are regular members, the determination unit 12 determines the first charge and the first privilege as shown in FIG. 2.

Further, for example, as shown in FIG. 2, in the case where the first spot is “A SPOT”, where the number of premium members that hope to use the returned vehicle is one and where the first date and time is “12: 00˜17: 00”, the determination unit 12 adopts a charge resulting from discounting 55% from an original charge, as the first charge, and adopts provision of 500 points, as the first privilege.

Meanwhile, in the case where the first spot and users that hope to use the returned vehicle are the same as those in the above example and where the first date and time is “17: 00˜22: 00” differently from that in the above example, the determination unit 12 adopts a charge resulting from discounting 15% from an original charge, as the first charge, and adopts provision of 100 points, as the first privilege. Similarly, in the case where the first spot is “B SPOT”, where the first date and time is “7: 00˜12: 00” or where users that hope to use the returned vehicle are regular members, the determination unit 12 determines the first charge and the first privilege as shown in FIG. 2.

Further, the determination unit 12 performs at least one of a process of decreasing the first charge as a demand for the vehicle at the first spot in a predetermined time after the first date and time is higher and a process of increasing the first privilege as the demand is higher. Alternatively, the determination unit 12 performs at least one of a process of decreasing the first charge as a demand for the car sharing service at the first spot in a predetermined time after the first date and time is higher and a process of increasing the first privilege as the demand is higher. Here, the demand is at least one of the number and grades of users that hopes to use the vehicle for the car sharing.

Specifically, the determination unit 12 performs at least one of a process of decreasing the first charge as the number of users that hope to use the returned vehicle at the first spot in the predetermined time after the first date and time is larger and a process of increasing the first privilege as the number of the users is larger. Alternatively, the determination unit 12 performs at least one of a process of decreasing the first charge as the number of users that hope to use the car sharing service at the first spot in the predetermined time after the first date and time is larger and a process of increasing the first privilege as the number of the users is larger.

For example, as shown in FIG. 2, in the case where the first spot is “A SPOT”, where the first date and time is “7: 00˜12: 00” and where the number of regular members that hope to use the returned vehicle is one or more and less than ten, the determination unit 12 adopts a charge resulting from discounting 30% from an original charge, as the first charge. Meanwhile, in the case where the first spot and the first date and time are the same as those in the above example and where the number of regular members that hope to use the returned vehicle is ten or more differently from that in the above example, the determination unit 12 adopts a charge resulting from discounting 35% from an original charge, as the first charge, and adopts provision of 300 points, as the first privilege. Similarly, in the case where the first date and time is “12: 00˜17: 00” or “17: 00˜22: 00” or where the first spot is “B SPOT”, the determination unit 12 determines the first charge and the first privilege as shown in FIG. 2.

Further, specifically, the determination unit 12 performs at least one of a process of decreasing the first charge as the grades of users (second user) that hope to use the returned vehicle at the first spot in the predetermined time after the first date and time are higher and a process of increasing the first privilege as the grades of the users are higher. Alternatively, the determination unit 12 performs at least one of a process of decreasing the first charge as the grades of users that hope to use the car sharing service at the first spot in the predetermined time after the first date and time are higher and a process of increasing the first privilege as the grades of the users are higher.

For example, as shown in FIG. 2, in the case where the first spot is “A SPOT”, where the first date and time is “17: 00˜22: 00” and where the number of regular members that hope to use the returned vehicle is one, the determination unit 12 adopts a charge resulting from discounting 10% from an original charge, as the first charge. Meanwhile, in the case where the first spot and the first date and time are the same as those in the above example and where the number of premium members that hope to use the returned vehicle is one differently from that in the above example, the determination unit 12 adopts a charge resulting from discounting 15% from an original charge, as the first charge, and adopts provision of 100 points, as the first privilege. Similarly, in the case where the first date and time is “7: 00˜12: 00” or “12: 00˜17: 00” or where the first spot is “B SPOT”, the determination unit 12 determines the first charge and the first privilege as shown in FIG. 2.

The grade of the user is not limited to the above-described content, and for example, may be determined by whether the user is an individual or a corporation.

Further, the determination unit 12 can determine at least one of a second charge and a second privilege based on the preliminary information. The second charge is a charge about the use of the vehicle when the vehicle is returned at the second spot on the second date and time, and is lower than the first charge. The second privilege is a privilege about the use of the vehicle when the vehicle is returned at the second spot on the second date and time, and is higher than the first privilege.

For example, as shown in FIG. 2, in the case where the first spot is “A SPOT”, where the first date and time is “12: 00˜17: 00” and where the number of regular members that hope to use the returned vehicle is ten or more, the determination unit 12 adopts a charge resulting from discounting 55% from an original charge, as the first charge, and adopts provision of 500 points, as the first privilege. Meanwhile, as shown in FIG. 3, in the case where the second spot is “C SPOT” different from “A SPOT”, where the second date and time is the same as the first date and time and where the number of regular members that hope to use the returned vehicle is ten or more, the determination unit 12 adopts a charge resulting from discounting 65% from an original charge, as the second charge, and adopts provision of 600 points, as the second privilege. It is allowed for the determination unit 12 not to determine at least one of the second charge and the second privilege. Further, the determination unit 12 may perform at least one of a process of decreasing the second charge as the second spot is closer to the first spot and a process of increasing the second privilege as the second spot is closer to the first spot.

The sending unit 13 sends information indicating at least one of the first charge and the first privilege. Further, the sending unit 13 may send information indicating at least one of the second charge and the second privilege.

The storage unit 14 is a storage medium that stores at least one of the relation shown in FIG. 2 and the relation shown in FIG. 3, and for example, is a random access memory (RAM) or a static random access memory (SRAM). The storage unit 14 stores the first spot and at least one second spot, in association with each other. The relation shown in FIG. 2 and the relation shown in FIG. 3, which are stored in the storage unit 14, may be determined based on performance of the car sharing service provided in the past, or may be determined based on the current reservation condition.

The input unit 21 accepts input of the return information. For example, the input unit 21 is a graphical user interface (GUI) or a human machine interface (HMI). The input unit 21 is used, when the use inputs, to the terminal 20, at least one of a user's ID, a user's password, the first spot and the first date and time.

The sending unit 22 sends the return information. Specifically, to the acquisition unit 11, the sending unit 22 sends information indicating at least one of the first spot, first date and time, second spot and second date and time input by the user with use of the input unit 21.

From the sending unit 13, the receiving unit 23 receives information indicating at least one of the first charge, the first privilege, the second charge and the second privilege.

The output unit 24 is a device that is used when the user is notified of at least one of the first charge, the first privilege, the second charge and the second privilege, and is a display or a speaker, for example.

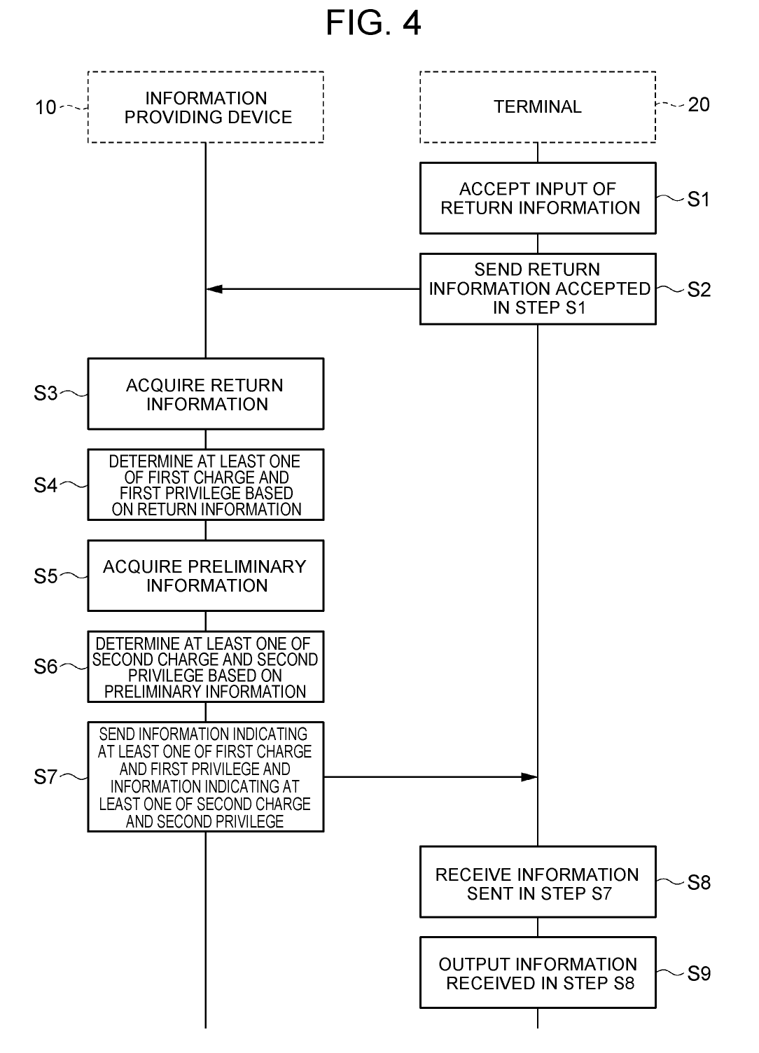

An exemplary process to be performed by the information providing device 10 and the terminal 20 according to the embodiment will be described with reference to FIG. 4.

In step S1, the input unit 21 accepts the input of the return information.

In step S2, the sending unit 22 sends the return information accepted in step S1.

In step S3, the acquisition unit 11 acquires the return information.

In step S4, the determination unit 12 determines at least one of the first charge and the first privilege based on the return information.

In step S5, the acquisition unit 11 acquires the preliminary information.

In step S6, the determination unit 12 determines at least one of the second charge and the second privilege based on the preliminary information.

In step S7, the sending unit 13 sends the information indicating at least one of the first charge and the first privilege and the information indicating at least one of the second charge and the second privilege.

In step S8, the receiving unit 23 receives the information sent in step S7.

In step S9, the output unit 24 outputs the information received in step S8.

Step S5 and step S6 are not essential. The information providing device 10 may send only the information indicating the first charge and the first privilege, in step S7.

The embodiment as an example of the disclosure has been described above. The information providing device 10 includes the acquisition unit 11, the determination unit 12 and the sending unit 13. The acquisition unit 11 acquires the return information indicating the first spot and the first date and time. The first spot is a spot where the user hopes to return the vehicle. The first date and time is a date and time when the user hopes to return the vehicle. The determination unit 12 determines at least one of the first charge and the first privilege based on the return information. The first charge is a charge about the use of the vehicle when the vehicle is returned at the first spot on the first date and time. The first privilege is a privilege about the use of the vehicle when the vehicle is returned at the first spot on the first date and time. The sending unit 13 sends the information indicating at least one of the first charge and the first privilege.

Therefore, the information providing device 10 can prompt the user to return the vehicle for the car sharing after the use, at a place where the demand is high, and can lead the vehicle for the car sharing to the place where the demand is high.

In the information providing device 10, the acquisition unit 11 further acquires the preliminary information indicating the second spot and the second date and time. The second spot is different from the first spot. The second date and time is a date and time when the vehicle is returned at the second spot. The determination unit 12 further determines at least one of the second charge and the second privilege based on the preliminary information. The second charge is a charge about the use of the vehicle when the vehicle is returned at the second spot on the second date and time, and is lower than the first charge. The second privilege is a privilege about the use of the vehicle when the vehicle is returned at the second spot on the second date and time, and is higher than the first privilege. The sending unit 13 further sends the information indicating at least one of the second charge and the second privilege.

Therefore, in the case where the demand for the vehicle for the car sharing after the use is higher at the second spot than at the first spot, the information providing device 10 can prompt the user to return the vehicle at the second spot, and can lead the vehicle for the car sharing to a place where the demand is higher.

The disclosure is not limited to the above-described embodiment, and can be carried out in various forms, without departing from the spirit of the disclosure. Therefore, the above-described embodiment is merely an example in all respects, and is not interpreted in a limited way. For example, the above-described processing steps can be executed in an arbitrarily modified order, or can be executed in parallel, as long as there is no inconsistency among processing contents.

What is claimed is:

1. An information providing device comprising:
an acquisition unit configured to acquire return information indicating a first spot and a first date and time, the first spot being a spot where a first user hopes to return a vehicle, the first date and time being a date and time when the first user hopes to return the vehicle;
a determination unit configured to determine at least one of a first charge and a first privilege based on the return information, the first charge being a charge about use of the vehicle when the vehicle is returned at the first spot on the first date and time, the first privilege being a privilege about the use of the vehicle when the vehicle is returned at the first spot on the first date and time; and
a sending unit configured to send information indicating at least one of the first charge and the first privilege.

2. The information providing device according to claim 1, wherein the determination unit is configured to perform at least one of a process of decreasing the first charge as a demand is higher and a process of increasing the first privilege as the demand is higher, the demand being a demand for the vehicle at the first spot in a predetermined time after the first date and time.

3. The information providing device according to claim 2, wherein the determination unit is configured to perform at least one of a process of decreasing the first charge as the number of users is larger and a process of increasing the first privilege as the number of the users is larger, each of the users being a user that hopes to use the vehicle that is to be returned at the first spot in the predetermined time after the first date and time.

4. The information providing device according to claim 2, wherein the determination unit is configured to perform at least one of a process of decreasing the first charge as a grade of a second user is higher and a process of increasing the first privilege as the grade of the second user is higher, the second user being a user that hopes to use the vehicle that is to be returned at the first spot in the predetermined time after the first date and time.

5. The information providing device according to claim 1, wherein the determination unit is configured to perform at least one of a process of decreasing the first charge as a demand is higher and a process of increasing the first privilege as the demand is higher, the demand being a demand for a car sharing service at the first spot in a predetermined time after the first date and time.

6. The information providing device according to claim 5, wherein the determination unit is configured to perform at least one of a process of decreasing the first charge as the number of users is larger and a process of increasing the first privilege as the number of the users is larger, each of the users being a user that hopes to use the car sharing service at the first spot in the predetermined time after the first date and time.

7. The information providing device according to claim 5, wherein the determination unit is configured to perform at least one of a process of decreasing the first charge as a grade of a second user is higher and a process of increasing the first privilege as the grade of the second user is higher, the second user being a user that hopes to use the car sharing service at the first spot in the predetermined time after the first date and time.

8. The information providing device according to claim 1, wherein:
the acquisition unit is configured to further acquire preliminary information indicating a second spot and a second date and time, the second spot being different from the first spot, the second date and time being a date and time when the vehicle is returned at the second spot;
the determination unit is configured to further determine at least one of a second charge and a second privilege based on the preliminary information, the second charge being a charge about the use of the vehicle when the vehicle is returned at the second spot on the second date and time and being lower than the first charge, the second privilege being a privilege about the use of the vehicle when the vehicle is returned at the second spot on the second date and time and being higher than the first privilege; and
the sending unit is configured to further send information indicating at least one of the second charge and the second privilege.

9. A non-transitory computer readable storage medium having computer program instructions stored on the non-transitory computer readable storage medium, when executed by a computer, the computer program instructions can cause the computer to execute:
an acquisition function to acquire return information indicating a first spot and a first date and time, the first spot being a spot where a user hopes to return a vehicle, the first date and time being a date and time when the user hopes to return the vehicle;
a determination function to determine at least one of a first charge and a first privilege based on the return information, the first charge being a charge about use of the vehicle when the vehicle is returned at the first spot on the first date and time, the first privilege being a privilege about the use of the vehicle when the vehicle is returned at the first spot on the first date and time; and
a sending function to send information indicating at least one of the first charge and the first privilege.

10. An information providing method comprising:
acquiring return information indicating a first spot and a first date and time, the first spot being a spot where a user hopes to return a vehicle, the first date and time being a date and time when the user hopes to return the vehicle;
determining at least one of a first charge and a first privilege based on the return information, the first charge being a charge about use of the vehicle when the vehicle is returned at the first spot on the first date and time, the first privilege being a privilege about the use of the vehicle when the vehicle is returned at the first spot on the first date and time; and
sending information indicating at least one of the first charge and the first privilege.
